(19) United States
(12) Patent Application Publication
(10) Pub. No.: US 2005/0167368 A1
(43) Pub. Date: Aug. 4, 2005

(54) Method and device for post-treating waste water from sewage plants

(75) Inventors: Peter Gehringer, Wien (AT); Hans-Peter Bierbaumer, Rohr (AT)

Correspondence Address: LERNER AND GREENBERG, PA, P O BOX 2480, HOLLYWOOD, FL, 33022-2480, US

(73) Assignee: Mediscan GmbH & Co. KG

(21) Appl. No.: 11/057,633

(22) Filed: Feb. 14, 2005

Related U.S. Application Data
(63) Continuation of application No. PCT/AT03/00221, filed on Jul. 31, 2003.

(30) Foreign Application Priority Data
Aug. 14, 2002 (AT) A 1234/2002

(51) Int. Cl. C02F 1/30

(52) U.S. Cl. 210/748

(57) ABSTRACT

A method and a device allow treating waste water discharged from a purification or sewage treatment plant for local waste water. An amount of endocrinically active hormones and hormones dangerous to aquatic environments or hormone metabolites from the group of oestranes contained in the discharged water is reduced in the flow of the waste water leaving the waste-water purification or sewage plant by guiding the same in the form of a continuous fluid body through the field or radiation cone of a radiation source emitting ionizing radiation (gamma, x-ray, and/or electron radiation).

### CROSS-REFERENCE TO RELATED APPLICATION

This is a continuing application, under 35 U.S.C. § 120, of copending international application No. PCT/AT2003/000221, filed Jul. 31, 2003, which designated the United States; this application also claims the priority, under 35 U.S.C. § 119, of Austrian patent application No. A 1234/2002, filed Aug. 14, 2002; the prior applications are herewith incorporated by reference in their entirety.

### BACKGROUND OF THE INVENTION

### FIELD OF THE INVENTION

The present invention relates to a novel method for the post-treatment of waste water or for treating waste water discharged from a purification or sewage-treatment plant for municipal waste water, and to a device for carrying out the method, use of the method, and use of the device.

In recent years, substances that cause subacute chronic toxic effects, in particular endocrine effects, have become the center of interest for ecological investigations. For example, there have been investigations that have as their objective the development of methods to identify contamination of the aquatic environment by endocrinally active substances. Ultimately, the results of such investigations are intended to protect aquatic biotopes and—closely linked to this—drinking-water resources and thus, in the final analysis, human life. The active mechanisms and the question as to which components of the endocrine system of animals that live in water, in particular fishes, are to be used to determine the endocrine effect are the objects of ongoing research projects aimed at answering the question as to the extent to which contamination of bodies of water can result in active contamination of aquatic ecosystems, of drinking water and, as a consequence of this, of other foodstuffs with—not least of all—the question as to the chronic effects and late sequelae in humans also being considered.

With respect to the impact of hormones in water, by way of example reference is had to the paper by Routledge et al (1998) titled “Identification of Estrogenic Chemicals in STW [Sewage Treatment Work] Effluent 2. In Vivo Responses in Trout and Roach,” Enviro. Sci. Technol., 32, 1559-1565, which states that by introducing treated waste water from municipal sewage treatment plants into rivers, detectable quantities of estranes that are sufficient to cause endocrine-toxic effects in fish are introduced into such rivers.

Reference is also had to a recently published work in Water and Wastewater International, Vol. 18, p. 5 (February 2003) in which it is reported that the estrogen designated therein as “endocrine disrupting” was recently included in the U.S. National Toxicology Program's list of carcinogenic substances.

Our own investigations have provided the unexpected result that when municipal waste water is treated in large city waste-water treatment plants, which is extremely costly and intensive in and of itself, there is practically no, or only an extremely small, breakdown of the (human) endocrinally active hormones, in particular those from the group of estranes, to form catabolites that are no longer endocrinally active.

It was found that the substances from the class of hormones can be biologically decomposed to only a very limited extent and for all practical purposes are therefore discharged from sewage treatment plants in the treated water at concentrations in which they are just as active as they were previously.

With respect to the problems addressed in the introduction hereto, which were in no way addressed completely with regard to their scope and importance, or with regard to their long-term effects and disadvantageous synergies with other problem and/or toxic substances contained in the waste water, even in small quantities, and which can scarcely be assessed, either qualitatively or quantitatively, it is the objective of the present invention to develop a method that makes it possible to achieve the breakdown of endocrinally active substances that cannot be achieved in waste-water treatment plants, in a subsequent stage of the treatment process or a post-treatment stage so as to arrive at the degree that is either desired, or desired or considered necessary from the ecological standpoint.

### SUMMARY OF THE INVENTION

It is accordingly an object of the invention to provide a method of after-treating water issuing from purification or sewage treatment plants which overcomes the above-mentioned disadvantages of the heretofore-known devices and methods of this general type and which answers the above call for the reduction in endocrine substances.

With the foregoing and other objects in view there is provided, in accordance with the invention, a method of treating waste water discharged from a water purification or sewage treatment plant, the method which comprises:
providing waste water containing an amount of organic substances including endocrinally active hormones and hormones dangerous to aquatic environments or hormone metabolites from the group of estranes, and particularly estrogens;
reducing the amount of organic substances contained in the waste water substantially solely by guiding the water in form of a continuous fluid body through a field or radiation cone of at least one radiation source emitting ionizing radiation selected from the group consisting of gamma radiation, x-ray radiation, and electron radiation, and substantially without adding either one of ozone or oxygen.

Thus, the objective of the present invention is a method of the kind described in the introduction hereto, which is characterized in that the quantity of endocrinally active hormones or hormone dangerous to aquatic environments or hormone metabolites from the group of estranes, in particular estrogens, contained in the waste water discharged from the sewage-treatment plant, the content of this waste-water flow is reduced in the flow of the waste water leaving the waste-water purification plant by guiding the same in the form of a continuous fluid body through the field or radiation cone of a radiation source emitting at least one type of ionizing radiation from the group of gamma, x-ray, and electron radiation.

Before the present inventions and its attendant advantages are described in greater detail it must in general be stated that for some time methods—in part proven in practice—for raising the purity of near-drinking-quality water, fairly pure from the outset and containing, apart from the natural contents of drinking water, small quantities of other constituents, to the levels prescribed by official standards or regulations, have been known for some time.

These methods provide for the treatment of water with ionizing radiation, the use of electron irradiation being preferred in view of ease with which it can be controlled and the possibility of simply “switching off” the radiation.

In this respect, particular reference is had to Austrian patent AT 392 462 C, which relates to the breakdown of chlorinated ethylenes in pure water; to Austrian patent AT 405 173 C, which deals with the reduction of the content of triazine derivatives in such water; to Austrian patent AT 407 521 C, the object of which is to render harmless genetically toxic active substances in water; and finally to Austrian patent AT 399 863 C, which deals with the reduction of the microorganism count in water intended for drinking.

All of these prior art methods involve using ionizing radiation to treat water that is close to drinking-water quality, which is to say water that frequently contains very little contamination and relatively small quantities of other constituents, with ionizing radiation.

Common to all these methods is the fact that the breakdown of injurious substances or the inactivation of microorganisms is effected by the water radicals formed in the water by the action of ionizing radiation. Since the radicals so formed are extremely amenable to reaction, they react not only in the desired manner with injurious substances or microorganisms, but also with nearly all the other constituents found in the water. From this it follows that the efficiency with which the injurious substances are broken down or the inactivation of microorganisms is determined to a large extent by the water constituents contained in the water and by the concentration of said constituents. Since the concentration of these constituents in drinking water is significantly lower than in the waste water discharged from sewage plants, when drinking water is treated with ionizing radiation, conditions are particularly favorable for the successful breakdown of hazardous substances or the inactivation of microorganisms.

In addition to the prior art represented by the above-cited patents in the field of drinking-water processing, particular mention should be made of the fact that the successful breakdown of injurious substances in the water that is contaminated by them is in no way achieved solely by treating the output water with ionizing radiation, but only in that—in addition to the action of the ionizing radiation—ozone is simultaneously introduced into the water that is to be made potable in order to achieve the success striven for in the above documents, namely a significant and specific breakdown of the injurious substances referred to.

For the technological background in the field of waste-water treatment, reference is also had to German patent DE 25 46 756 C, which has as its objective the sanitizing treatment of municipal sewage sludge by electron radiation in a channel so as to reduce the extremely high microorganism count contained in it.

According to that patent specification—obviously because of the low efficiency of ionizing irradiation alone—provision is made for the additional introduction of oxygen into the sewage sludge exposed to this radiation, the actual effectiveness of the additional introduction of oxygen being attributed to the ozone formed from the oxygen, in part by the applied radiation.

Sewage-sludge sanitization by irradiation has already been instituted in Geiselbullach, Germany, where gamma radiation was used. But even when sewage sludge is subjected to gamma irradiation, for reasons of economy it was impossible to dispense with the additional introduction of oxygen into the sewage sludge that is to be treated.

With regard to the need for the simultaneous effect of ionizing radiation and ozone or oxygen to achieve the desired objective of breaking down injurious substances or the inactivation of microorganisms, which is considered indispensable for improving water to drinking-water quality and also for sanitizing sewage sludge, the above-described, detailed trials with, and investigations of waste water discharged from, waste-water treatment plants has provided the following surprising findings:
The injurious substances that remain largely unaffected by the previous waste-water treatment process and which are contained in the nanogram per liter range, such as, in particular, the hormones referred to heretofore, which are present in the waste water in a matrix that has an content of organic substances, such as a CSB value of more than 100 mg/L and a TOC value of 30 to 40 mg/L, that is comparatively extremely high and, as expected, consumes the major portion of the radiation energy, can be broken down in a thoroughly effective manner to form substances that clearly are no longer endocrinally or estrogenically active, solely by the action of ionizing radiation and without any additional, simultaneous introduction of ozone and/or oxygen and without another additive the promotes the breakdown of organic substances, and without measures that promote this breakdown.

Most surprisingly, it was also found that even without the help of ozone and/or oxygen, at the dosage rate that is used in each instance to reduce the hormone content in the particular waste water, the ionizing radiation is able to reduce to a considerable extent the number of microorganisms, in particular those from the group of coliform bacteria, that are present in the discharged waste water, and do this without detracting from the desired hormone breakdown.

As for the radiation dose that is most favorable for the effective breakdown of hormones in the waste-water fluid body—as was found, essentially independently of the type of radiation—we suggest preferred ranges of the radiation dose to be used from the standpoint of economy. If the radiation dose rates of the following paragraphs are used, one can anticipate a hormone breakdown of up to three orders of magnitude. If electron radiation is used, the use of electron accelerators in the energy range of 0.5 to 5 MeV is especially recommended.

In accordance with a preferred embodiment of the invention, therefore, the fluid body of the waste-water flow with an original total hormone content from the group of estranes of up to 250 ng/L is exposed to a radiation field with a radiation dose of 300 to 5000 Gy, preferably between 500 and 3000 Gy, and most particularly between 500 and 2500 Gy, to thereby reduce the total hormone content in the fluid body to estrogen activity values that can no longer be detected by bioanalytical tests.

In accordance with another feature of the invention, the total hormone content is reduced to estrogen activity values that can no longer be detected with yeast-estrogen receptor tests.

These limits, i.e., the non-detectability, are defined as to the current state of the art of detection and analysis.

In accordance with an additional feature of the invention, the fluid body of the waste-water flow is exposed to a radiation field with a substantially constant radiation dose of 300 to 5000 Gy, to reduce a coliform bacteria content of the waste water by at least one power of ten simultaneously with a reduction of a content of hormones of the estrane group.

Unexpectedly high microorganism inactivation is simultaneously achieved within the framework of the present invention, the extent of which can lie in the range from 2 to 5 powers of ten when, at the same time—and as discussed above—the efficiency of the hormone breakdown, most surprisingly remains unimpaired.

In accordance with an additional feature of the invention, it is in principle favorable to ensure a type of intensive exchange of the volume-strata of the fluid body that are close to the radiation source with the strata that are further removed from the outer strata of the source.

This may be achieved, for example, by intimately and thoroughly mixing a volume flow of the fluid body of waste water passing through the radiation field in an effective area of the ionizing radiation, wherein a partial volume of the fluid body proximate to the source of radiation is mixed intensively and thoroughly with a partial volume of the fluid body remote from the source of radiation.

In accordance with a further feature of the invention, turbulence may be created in the fluid body of waste water passing through the radiation field in an effective area of the ionizing radiation with a turbulence-generating fittings in a through-flow cell defining the fluid body and/or at least one rotating body in a through-flow cell defining the fluid body. The latter may preferably be rotated with a non-contact drive system.

In accordance with an advantageous feature of the invention, the method comprises irradiating with electron radiation from an electron accelerator, and causing the flow of waste water to assume a stratified, flat fluid body. The irradiation is preferably effected transversely or even perpendicular to the stratified fluid body.

In view of the extremely small quantity of hormones to be broken down and the simultaneous presence of large quantities of matrix materials in the discharged water, it has been found beneficial—in the sense of the most multilateral possible exposure of the waste water to the radiation—to ensure a turbulent flow in the fluid body of the waste water, in which respect reference is made to the detail in Claim 6.

A most beneficial form of the fluid body in the event that electron radiation is used for achieving optimal results of hormone reduction, would be to conduct the fluid body through an effective area of the radiation with a fluid surface unobstructed towards the at least one radiation source.

If electron radiation is used, in order to avoid radiation losses that occur when a closed radiation-exposure chamber that incorporates a radiation window is used, it has been shown to be advantageous to work with a chamber that has no such window to the radiation source.

With the above and other objects in view there is also provided, in accordance with the invention, a device for treating waste water discharged from a water purification or sewage treatment plant, the waste water containing an amount of organic substances including endocrinally active hormones and hormones dangerous to aquatic environments or hormone metabolites from the group of estranes. The device comprises:
an electron radiation source configured to reduce the amount of organic substances contained in the waste water substantially without adding either one of ozone or oxygen;
at least one radiation-exposure chamber or radiation-exposure cell disposed in an effective area of electron radiation generated by said electron radiation source, formed with an inlet for receiving waste water that contains hormones and originates from a municipal waste-water treatment plant, an outlet for waste water with a reduced hormone content, and a window transparent to radiation or open to the radiation and facing said electron radiation source, and configured to effect a formation of a substantially stratified, flat, and continuously flowing fluid body.

As discussed briefly above, another important object of the present invention is a device for carrying out the new waste water post-treatment or waste water treatment method as defined in Claim 9, which is characterized in that—if electron radiation is used—it includes an open radiation-exposure chamber or cell that is disposed in the area of the radiation cone or field of the electron accelerator, transversely, preferably essentially perpendicular to the direction of the radiation; this radiation-exposure chamber or cell incorporates an inlet for water discharged from a municipal sewage-treatment plant, which contains hormones of the estrane group, and at least one outlet for waste water with a reduce hormone content. The radiation-exposure chamber or cell generates an essentially laminar, flat, continuously flowing fluid body incorporates a window that is transparent to radiation or open to this.

Although the invention is described herein as embodied in a method and device for post-treating waste water from sewage treatment and purification plants, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments and examples.

### EXAMPLE 1

For the tests described in this example, waste water from a municipal waste-water purification plant after a heavy rainfall was used. The relevant specifications were as follows:

| | | | |
|---|---|---|---|
| CSB | 124 mg/L; | TOC | 37 mg/L; |
| BSB₅ | 41 mg/L; | TSS | 44 mg/L; |
| Total-N | 38 mg/L; | Total-P | 2.4 mg/L |

In addition, the water contained estranes at the following concentrations:

| | | | |
|---|---|---|---|
| estron | 20 ng/L; | 17a-estradiole | 2.6 ng/L; |
| 17b-estradiole | 2.3 ng/L; | estriole | 24 ng/L; |
| ethinylestradiole | 4.2 ng/L. | | |

This water also contained considerable quantities of coliform bacteria, namely:
930,000/100 ml total coliforms;
480,000/100 ml fecal coliform; and
346,590/100 ml e.coli.

This water was treated by both electron irradiation and gamma irradiation. A laboratory located in the Seibersdorf Research Center performed the electron irradiation; this made it possible to vary the stratum thickness of the waste water flowing through the flat prismatic radiation chamber between 1 and 3 mm.

In the 3-mm stratum height arrangement, wires were welded to the bottom of the radiation chamber in a herringbone pattern so as to increase the amount of turbulence.

The electron accelerator, which delivers 500 keV, was powered with current strengths between 2 and 8 mA in order to apply the required radiation doses, as can be seen from the table of results that follows.

A cobalt-60 Gammacell 220 made by Nordion, Canada, was used to irradiate the waste water with gamma radiation, at a dose power of approximately 0.9 Gy/s.

Examination of the waste water before and after the action of the particular radiation was conducted in the laboratories of the Federal Office of the Environment, Vienna. The procedure used was as follows:

In each instance, 0.1-liter samples of the waste water was dosed with isotope marked standards for each analyte, purified by liquid-liquid extraction, and the analytes were enriched through the C-18 solid phase. After column-chromatographic purification (NH2 phase and derivatisation with n-methyl-n-trimethylsilyltrifluoracetamide (MSTFA), the samples were measured by gas chromatography/high-resolution mass spectrometry (GC/HRMS) at a resolution of 8000.

The following Table 1 illustrates the results of reducing the hormone contents in the waste water by the action of electrons as well as gamma radiation at various dose rates:

| | | Concentration in ng/Liter in waste water | | | | | | | |
|---|---|---|---|---|---|---|---|---|---|
| | | | | | | 17a- | Bacillus count in 100 ml | | |
| Radiation | | | | | | ethinyl- | Total | Fecal | |
| Method | Dose Gy | Estron | 17a-estradiol | 17b-estradiol | Estriole | estradiol | coliform | coliform | E-coli |
| 500 KeV | 0 | 20 | 2.6 | 2.3 | 2.4 | 4.2 | 930,000 | 480,000 | 346,590 |
| electrons, | | | | | | | | | |
| Water | 250 | — | — | — | — | — | 240,000 | 24,000 | 76,830 |
| stratum | | | | | | | | | |
| 1 mm | | | | | | | | | |
| | 500 | 12 | 0.9 | 0.3 | 14 | 1.4 | 4800 | 4800 | 8720 |
| | 750 | — | — | — | — | — | 930 | 480 | 1270 |
| | 1000 | 5.9 | 0.6 | 0.4 | 8.1 | Not | 48 | 150 | 610 |
| | | | | | | detectable | | | |
| | 2000 | 1.7 | 0.6 | 0.3 | Not | Not | — | — | — |
| | | | | | detectable | detectable | | | |
| | 5000 | <0.3 | Not | Not | Not | Not | — | — | — |
| | | | detectable | detectable | detectable | detectable | | | |
| 500 KeV | 0 | 20 | 2.6 | 2.3 | 24 | 4.2 | | | |
| electrons, | | | | | | | | | |
| Water | 250 | — | — | — | — | — | | | |
| stratum | | | | | | | | | |
| 3 mm | | | | | | | | | |
| | 500 | 12 | 1 | 0.3 | 15 | 1.6 | | | |
| | 750 | — | — | — | — | — | | | |
| | 1000 | 6.2 | 0.6 | 0.4 | 9.1 | Not | | | |
| | | | | | | detectable | | | |
| | 2000 | 1.9 | 0.6 | Not | Not | Not | | | |
| | | | | detectable | detectable | detectable | | | |
| | 5000 | Not | Not | Not | Not | Not | | | |
| | | detectable | detectable | detectable | detectable | detectable | | | |
| Gamma | 0 | 20 | 2.6 | 2.3 | 24 | 4.2 | 930,000 | 460,000 | Not |
| Cells | | | | | | | | | determined |
| | 250 | — | — | — | — | — | 240,000 | 93,000 | Not |
| | | | | | | | | | determined |
| | 500 | 10 | 1 | 0.4 | 15 | 1.6 | 4800 | 9300 | 13,864 |
| | 750 | — | — | — | — | — | 2400 | 930 | 7101 |
| | 1000 | 4.5 | 0.6 | 0.4 | 8.2 | Not | 240 | 240 | 720 |
| | | | | | | detectable | | | |
| | 2000 | Not | Not | Not | Not | Not | — | — | |
| | | detectable | detectable | detectable | detectable | detectable | | | |
| | 5000 | Not | Not | Not | Not | Not | | | |
| | | detectable | detectable | detectable | detectable | detectable | | | |

### EXAMPLE 2

Samples of waste water from the same municipal treatment plant as in Example 1, collected during a period of fine weather, were tested biologically and bioanalytically after electron irradiation as described in Example 1, using different high dose rates. The tests, which are described below, were conducted in the Fraunhofer-Institute for Molecular Biology and Applied Ecology in Schmallenberg, Germany:

a) Chemical Analysis:

Filtration of the total sample through glass-fiber filter;

Aliquotization to 0.5-liter samples and dosing of the Internal Standard (IS);

SPE extraction on Macherey-Nagel CHROMABOND C18;

Purification of the extracts on activated silica gel;

Derivativization (silylation) with n-methyl-n-trimethylsilyltrifluoracetamide (MSTFA);

Measurement by means of ion-trap GC/MS/MS;

Quantification by standard addition method on four concentration stages (matrix calibration with non-irradiated sample).

b) Bioanalyis:

Testing for estrogen activity by means of the yeast-estrogen receptor test

Sample Preparation:

Filtration of the total sample through glass-fibre filter;

SPE extraction of 1-liter sample on Macherey-Nagel CHROMABOND C18;

Elution with acetone; concentration in a vacuum;

Dissolution of residue in 2 mL ethanol.

Yeast-Estrogen Receptor Test:

Test Organism:

Genetically modified yeast strain (saccharomyces cerevisiae), developed by GLAXO Research and Development Limited. This strain contains the DNA sequence of the Cup-hER human estrogen receptor, the expression plasid ERE, and the lac-Z receptor gene for the β-galactosidase, the activity of which forms a red dye.

Conduct:

The test was conducted in accordance with Routledge and Sumpter (Environ Toxicol. Chem. 15 (3), 241-248, 1996) in the modification by deBoever et al. 2001, Environ. Health Perspect., 109; 691-69). Two test series were completed for each sample extract, for each of which an effect curve was recorded with 17α-ethinyl-estradiole. Between 10 and 70 μl of the sample extracts was used in the yeast test.

Extinction of the enzyme activity (540 nm) was corrected by the turbidity (620 nm) (E540/E620) and related to the blind value (quotient blind value=1). The values so obtained were designated as “relative activity.” Test amounts whose cell densities were less than the negative controls (blank) were considered as cytotoxic and were not evaluated.

For relative activities that were in the range of a corresponding calibrating line, and the results obtained when this was done the ethinylestradiole equivalents contained in the samples are reported in the form of semi-quantitative activity values (+++++: highly estrogen active to +: very slightly estrogen active; nd: not detectable; nb: not determined).

The Table 2 that follows shows the results of chemical analysis and bioanalysis tests:

TABLE 2

| Electron | | Concentration (chemical analysis) ng/L | | | | | |
|---|---|---|---|---|---|---|---|
| radiation | | in waste water | | | | | Relative |
| Stratum | | | | | | 17a-ethinyl | estrogen |
| thickness 3 mm | | Estrogen | 17a-estradiole | 17b-estradiole | Estriole | estradiole | activity |
| | 0 | 110 | 32 | 6.6 | Nb | 20 | +++++ |
| | 1000 | Nd | Nd | Nd | Nb | Nd | + |
| | 2000 | Nd | Nd | Nd | Nb | Nd | 0 |
| | 3000 | Nd | Nd | Nd | Nb | Nd | 0 |

1. A method of treating waste water discharged from a water purification or sewage treatment plant, the method which comprises:
providing waste water containing an amount of organic substances including endocrinally active hormones and hormones dangerous to aquatic environments or hormone metabolites from the group of estranes;
reducing the amount of organic substances contained in the waste water substantially solely by guiding the water in form of a continuous fluid body through a field or radiation cone of at least one radiation source emitting ionizing radiation selected from the group consisting of gamma radiation, x-ray radiation, and electron radiation, and substantially without adding either one of ozone or oxygen.

2. The method according to claim 1, which comprises providing waste water containing an amount of estrogens.

3. The method according to claim 1, which comprises exposing the fluid body of the waste-water flow with an original total hormone content from the group of estranes of up to 250 ng/L to a radiation field with a radiation dose of 300 to 5000 Gy, to thereby reduce the total hormone content in the fluid body to estrogen activity values that can no longer be detected by bioanalytical tests.

4. The method according to claim 3, which comprises reducing the total hormone content to estrogen activity values that can no longer be detected with yeast-estrogen receptor tests.

5. The method according to claim 3, which comprises setting the radiation dose to between 500 and 3000 Gy.

6. The method according to claim 3, which comprises setting the radiation dose to between 500 and 2500 Gy.

7. The method according to claim 1, which comprises exposing the fluid body of the waste-water flow to a radiation field with a substantially constant radiation dose of 300 to 5000 Gy, to reduce a coliform bacteria content of the waste water by at least one power of ten simultaneously with a reduction of a content of hormones of the estrane group.

8. The method according to claim 1, which comprises intimately and thoroughly mixing a volume flow of the fluid body of waste water passing through the radiation field in an effective area of the ionizing radiation, wherein a partial volume of the fluid body proximate to the source of radiation is mixed intensively and thoroughly with a partial volume of the fluid body remote from the source of radiation.

9. The method according to claim 1, which comprises creating turbulence in the fluid body of waste water passing through the radiation field in an effective area of the ionizing radiation, by effecting at least one of the following:
placing turbulence-generating fittings in a through-flow cell defining the fluid body; and
placing at least one rotating body in a through-flow cell defining the fluid body.

10. The method according to claim 9, which further comprises causing the rotating body with a non-contact drive system.

11. The method according to claim 1, which comprises irradiating with electron radiation from an electron accelerator, and causing the flow of waste water to assume a stratified, flat fluid body.

12. The method according to claim 11, which comprises aligning a radiation cone of the electron accelerator to pass through the stratified, flat fluid body perpendicularly.

13. The method according to claim 1, which comprises conducting the fluid body through an effective area of the radiation with a fluid surface unobstructed towards the at least one radiation source.

14. A device for treating waste water discharged from a water purification or sewage treatment plant, the waste water containing an amount of organic substances including endocrinally active hormones and hormones dangerous to aquatic environments or hormone metabolites from the group of estranes, the device comprising:
an electron radiation source configured to reduce the amount of organic substances contained in the waste water substantially without adding either one of ozone or oxygen;
at least one radiation-exposure chamber or radiation-exposure cell disposed in an effective area of electron radiation generated by said electron radiation source, formed with an inlet for receiving waste water that contains hormones and originates from a municipal waste-water treatment plant, an outlet for waste water with a reduced hormone content, and a window transparent to radiation or open to the radiation and facing said electron radiation source, and configured to effect a formation of a substantially stratified, flat, and continuously flowing fluid body.

15. The device according to claim 14, wherein said electron radiation source is disposed to irradiate the fluid body substantially perpendicularly to a direction of flow.

16. The device according to claim 14, wherein:
said radiation exposure chamber or cell includes fittings configured to generate a turbulent flow; and
a vortexing device is disposed directly ahead of said radiation-exposure chamber or cell in a fluid flow direction for generating a turbulent flow in the fluid body of the waste water.

17. The device according to claim 16, wherein said fittings project from a wall of said radiation exposure chamber remote from said radiation source, and said vortexing device is an agitator.

18. The method according to claim 1, which comprises treating waste water from a municipal treatment plant for reducing the hormones and hormone metabolites from the group of estranes and simultaneously reducing a content of coliform bacteria.

19. A method of treating waste water discharged from a water purification or sewage treatment plant, the method which comprises:
providing a device according to claim 14 and conducting the waste water from a municipal treatment plant to the device; and
treating the waste water in the device to thereby reduce a content of hormones and hormone metabolites from the group of estranes that are endocrinally active and dangerous to aquatic environments, and simultaneously reducing a content of coliform bacteria.

20. The method according to claim 19, which comprises reducing the content to an amount below a detection limit of bioanalysis.
